(19) United States
(12) Patent Application Publication
(10) Pub. No.: US 2006/0011065 A1
(43) Pub. Date: Jan. 19, 2006

(54) Inlet nozzle for oxygen concentrator

(76) Inventor: John M. Hastings, Eden Prarie, MN (US)

Correspondence Address: Carl L. Johnson;Jacobson and Johnson, Suite 285, One West Water Street, St. Paul, MN, 55107-2080, US

(21) Appl. No.: 10/894,204

(22) Filed: Jul. 19, 2004

(51) Int. Cl. B01D 46/00

(52) U.S. Cl. 96/384

(57) ABSTRACT

An inlet nozzle for an oxygen concentrator wherein the inlet nozzle maintains the generally flow direction while dispersing the incoming fluid over an extended area to both reduce the wear on the filter as well as to reduce the acoustical noise.

### FIELD OF THE INVENTION

This invention relates to oxygen concentrators and, more specifically, to an inlet nozzle for an oxygen concentrator that reduces the acoustic noise or air stream noise as well as minimizes the wear on the filter of the oxygen concentrator.

### CROSS REFERENCE TO RELATED APPLICATIONS

None

### STATEMENT REGARDING FEDERALLY SPONSORED RESEARCH OR DEVELOPMENT

None

### REFERENCE TO A MICROFICHE APPENDIX

None

### BACKGROUND OF THE INVENTION

One of the problems with oxygen concentrators is that they generate acoustic or air stream noise as the air is drawn into the oxygen concentrators. To reduce the noise input silencers or mufflers that use padding are known in the art. An oxygen concentrator with an inlet silencer/filter is shown and described in Robert's U.S. Pat. No. 6,702,880. In general, a compressor draws ambient air through a nozzle and a filter removes unwanted particles from the air as it flow through the filter. One of the difficulties is that the particles which are moving with the air stream impinge with high velocity on the filter and can cause premature failure of the filter.

In addition to the mechanical noise generated by the operation of the compressor acoustical noise or air stream noise is also generated as the ambient air is drawn into the filter housing. In general, it was believed that to reduce the acoustical noise one should increase the flow resistance or pressure drop through the filter housing. Consequently, an offset nozzles in the form of an insert or a through the wall orifice have been used to increase the fluid flow resistance or pressure drop therethrough. By increasing the fluid resistance and hence the inefficiency of the system one would decrease the acoustical noise. In contrast, the present invention provides for acoustical noise reduction while at the same time improving the efficiency of the system by use of nozzle that directs and disperses the flowing air over an extended area of a filter.

### SUMMARY OF THE INVENTION

An inlet nozzle for an oxygen concentrator wherein the inlet nozzle contains an at least one fluid passage that substantially maintains the flow orientation of the air as it directs and disperses the incoming air over an extended area which both reduces the wear on the filter as well as reduces the acoustical noise of the system.

### BRIEF DESCRIPTION OF THE DRAWINGS

FIG. 1 shows a block diagram of a prior art oxygen concentrator;

FIG. 2 shows an exploded view of a prior art filter housing and inlet nozzle;

FIG. 3 shows a sectional view of prior art inlet nozzle of FIG. 2 showing the angled lip that funnels the inlet air along a side of an inlet passage to provide for reduced acoustical noise;

FIG. 4 shows a top view of the inlet nozzle of the present invention; and

FIG. 5 shows a cross sectional view of the inlet nozzle of the present invention.

### DESCRIPTION OF THE PREFERRED EMBODIMENT

FIG. 1 shows a block diagram of an oxygen concentrator system 10 comprising a filter housing 11 for filtering ambient air, a compressor 12 for drawing ambient air and an oxygen concentrator 13 for generating breathable oxygen from the ambient ari.

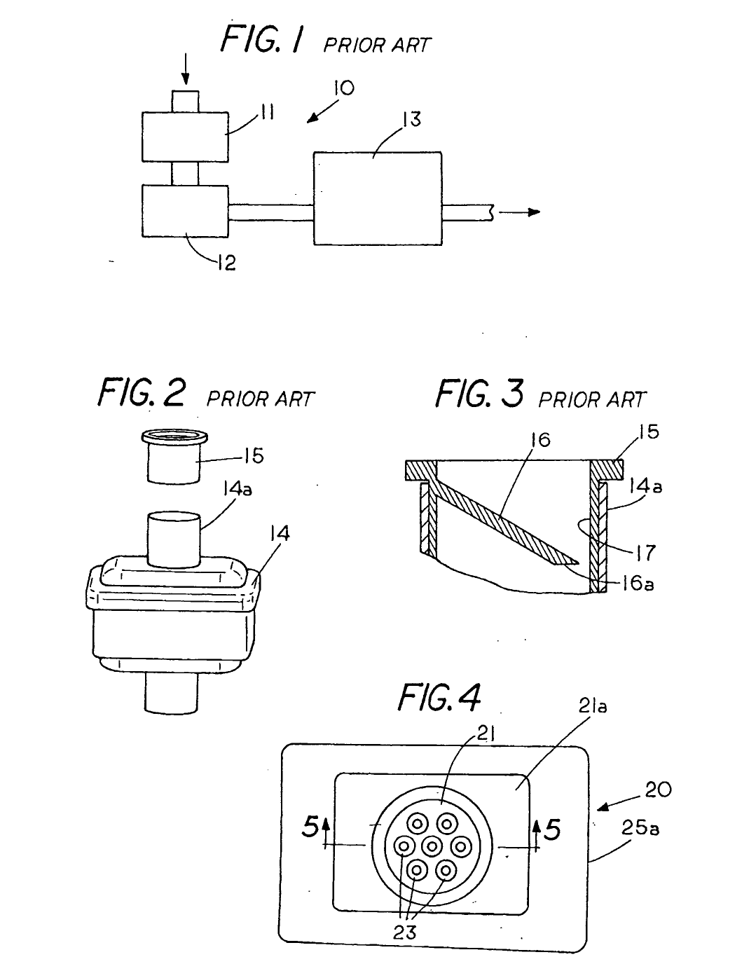

FIG. 2 shows an exploded view of a prior art filter housing 14 containing a filter (not shown) for removing particles from the incoming air. Located above filter housing 14 is a nozzle 15 that is insertable in a top extension 14a of filter housing 14.

FIG. 3 shows a cross sectional view of the top extension 14a with the inlet nozzle 15 in cross section to reveal a plate 16 that extends across the opening in the nozzle 15 to direct the incoming air over a lip 16a to cause the air to flow along side wall 17 and into filter housing 14. In general, it was believed that to reduce the acoustical noise in the proximity of the compressor one should increase the flow resistance or pressure drop through the filter housing and the embodiment of FIG. 3 increases the fluid resistance or pressure drop through the filter housing by directing the fluid along an angled throat plate toward a sidewall of the nozzle and eventually over a lip. This torturous path causes the fluid to change directiion and increases the pressure drop across the filter housing. Such increase in the inefficiency of the system was used to produce low levels of acoustical noise proximate the oxygen concentrator. In contrast, the present invention provides for acoustical noise abatement while at the same time improving the efficiency of the system by reducing the pressure drop or pressure losses through the filter housing.

FIG. 4 shows a top view of a filter housing 20 with the housing 18 carrying inlet nozzle 21 secured to housing 25a through a flange 21a. The inlet nozzle 21 includes a set of radially spaced apart fluid passages 23 that direct ambient atmospheric air into the filter housing 20. In the embodiment shown each of the unimpeded fluid passages 23 extends in a direction substantially parallel to each other and each of the fluid passage converges for about half its length. The inlet nozzle 21 for the oxygen concentrator comprises an at least one fluid passage 23 in the nozzle 21 for directing air through the nozzle. A base 21a on the nozzle 21 secures the nozzle to a filter housing 25a to enable air flowing through the nozzle 21 to enter the filter housing 25a.

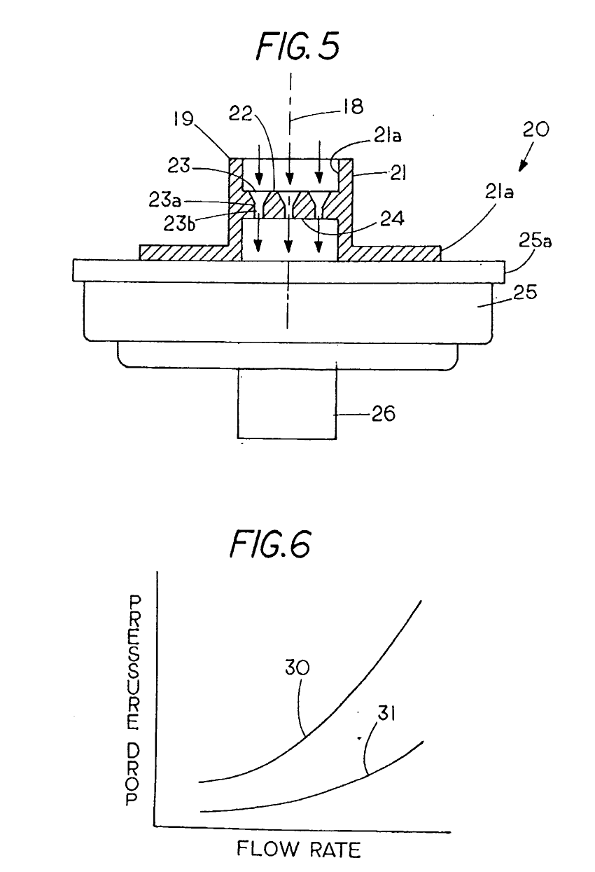

FIG. 5 shows a cross sectional view of the inlet nozzle 21 that comprises a one-piece molded inlet nozzle 21 having a plurality of spaced apart unimpeded fluid passages 23 therein. In the embodiment shown the inlet nozzle 21 includes an inlet conduit 21a, an external fluid face 22 having a plurality of fluid passages 23 extending through cross member 21b with the fluid passages exiting on internal fluid face 24. Each of the fluid passages 23 include a frusto conical converging region 23a and a cylindrical region of uniform cross section 23b. With a converging region the passages cause the velocity of the air flowing through the at least one fluid passage to be increased as it flows through the at least one fluid passage. Although a converging fluid passage is shown the fluid passage need not be converging to maintain the proper flow orientation through the fluid passages.

In operation of the inlet nozzle 21 the compressor connected to conduit 26 draws ambient air into the inlet conduit 21a. The arrows indicate the direction of flow of ambient air flow into the inlet nozzle as it enters the fluid passage 23. During normal compressor operation the fluid is drawn at sufficiently high flow rate so that turbulent flow occurs in the fluid passages in the inlet nozzle. As can be seen in FIG. 5 the direction of fluid flow through the cross member or throat plate 21b, which is located generally normal to the sidewall 21a, is generally maintained in the same direction even though dispersed. That is, the fluid flow through the inlet nozzle comprises a coaxial flow direction with respect to a central axis 18 of the inlet nozzle 21.

In order to appreciate the difference between the offset fluid entry of the prior art shown in FIG. 3 and the present invention reference should be made to FIG. 5 which shows the pressure drop as a function of flow rate. The top curve 30 illustrates the increase of pressure drop through the filter housing with increase of flow rate and the lower curve 31 illustrated\s the increase of pressure drop through the filter housing with increase in flow rate. In general it was believed that the generation of the higher pressure drop (curve 30) through the filter housing was preferable since it produces less acoustical noise in the proximity of the oxygen concentrator. Contrary to belief that the higher pressure drop in the filter housing was preferred in order to reduce acoustical noise, the measurement of the flow rate and the acoustical noise of the prior art offset nozzle of FIG. 3 revealed that the present invention, while having less pressure drop at the same flow rate, had actually lower acoustical noise. Tests revealed that the decibel level for the prior art inlet nozzle shown in FIG. 3 was 63 db at two feet from the filter housing. In contrast the decibel level for the present invention as shown in FIG. 4 and FIG. 5 was only 56.1 db. In addition the dispensing of the fluid over an extended area of the filter reduces localized wear on the filter due to particles in the ambient air being dispersed over a wider area of the filter in the filter housing.

Thus the embodiment of FIG. 5 shows an inlet nozzle 21 for an oxygen concentrator for providing reduced acoustical noise when connected to an oxygen concentrator comprising: a molded one piece polymer plastic housing 19 with a cross member or throat plate 21b having an external fluid face 22 thereon. Throat plate 21b extends from wall to wall of inlet conduit 21a. A plurality of unimpeded fluid passages 23 located in the housing with the plurality of fluid passages 23 each having an inlet 23a in external fluid face 22 for drawing ambient air into conduit 21a and into each of the plurality of fluid passages 23. The fluid discharges through an internal fluid face 24 on housing 19 through the plurality of unimpeded fluid passages 23 each having an outlet 23b in the internal fluid face 23 with a total inlet area of plurality of fluid passages 23 in the external fluid face 22 greater than a total outlet area of the plurality of fluid passages 23 in the internal fluid face 24.

Thus the present invention further includes method of reducing the acoustical noise in an oxygen concentrator by directing incoming air in a first direction into an inlet nozzle 21 by maintaining a downstream pressure less than atmospheric pressure at the inlet nozzle. By maintaining sufficiently low downstream pressure one can induce a turbulent air flow condition in at least one fluid passage 23 in the inlet nozzle 20 and by dispersing an outgoing air flow from the at least one fluid passage 23 in the inlet nozzle 20 over an extended area while maintaining the outgoing air flow in the first direction one thereby reduces acoustical noise while minimize pressure losses through the filter housing thus increasing the efficiency of the system.

While the invention is shown with a plurality of fluid passages located in cross member it is envisioned that a single continuous fluid passage that extends diametrically across the external face or a fluid passage or fluid passages that extend across the external face of the nozzle could also be used to disperse and direct the air into the filter housing while at the same time reducing the acoustical noise.

I claim:

1. An inlet nozzle for an oxygen concentrator for providing reduced acoustical noise when connected to an oxygen concentrator comprising:
a housing;
an external fluid face on said housing;
a plurality of unimpeded fluid passages located in said housing, said plurality of fluid passages each having an inlet in said external face for drawing air into each of said plurality of fluid passages; and
an internal fluid face on said housing, said plurality of unimpeded fluid passages each having an outlet in said internal fluid face with a total inlet area of said plurality of fluid passages in said internal fluid face greater than a total outlet area of the plurality of fluid passages in said external fluid face.

2. The inlet nozzle of claim 1 wherein each of the unimpeded fluid passages converges from said external fluid face to said internal fluid face.

3. The inlet nozzle of claim 1 wherein each of the unimpeded fluid passages extends in a direction substantially parallel to each other.

4. The inlet nozzle of claim 1 wherein the noise level at a distance of 2 feet from the nozzle is less than 57 decibels with turbulent flow therein.

5. A method of reducing the acoustical noise in an oxygen concentrator comprising:
directing incoming air in a first direction into an inlet nozzle by maintaining a downstream pressure less than an atmospheric pressure at the inlet nozzle;
maintaining sufficiently low downstream pressure so as to induce a turbulent air flow condition in at least one fluid passage in the inlet nozzle;
dispersing an outgoing air flow from the at least one fluid passage in the inlet nozzle over an extended area while maintaining the outgoing air flow in the first direction to thereby reduce acoustical noise and minimize pressure losses through the filter housing.

6. The method of claim 5 wherein the velocity of the air flowing through the at least one fluid passage is increased as it flows through the at least one fluid passage.

7. The method of claim 5 including the step of directing the air flowing through the nozzle into a plurality of fluid passages radially spaced from each other.

8. The method of claim 5 including the step of directing the air flowing through the at least one fluid passage in a direction normal to a throat plate in the nozzle.

9. The method of claim 5 wherein the step of directing incoming air through the at least one fluid passage comprises directing ambient air into the at least one fluid passage from an inlet conduit located upstream of the at least one fluid passage.

10. The method of claim 5 including the step of maintaining substantially the same flow direction of air as the air flows through the nozzle.

11. A one-piece inlet nozzle for an oxygen concentrator comprising:
an at least one fluid passage in said nozzle for directing air in a first direction through said nozzle; and
a base on said nozzle for securing said nozzle to a filter housing to enable air flowing through said nozzle to flow through said nozzle at substantially the same direction as the air entering said nozzle.

12. The inlet nozzle of claim 11 including a throat plate extending from wall-to-wall of said housing; and
at least one fluid passage located in said throat plate for directing and dispersing air from a first side of said throat plate to a second side of said throat plate while maintaining a reduced acoustical noise level.

12. The inlet nozzle of claim 11 wherein the inlet nozzle comprises a polymer plastic molded one-piece inlet nozzle.

13. The inlet nozzle of claim 11 wherein the at least one fluid passage has a flow direction generally parallel to a central axis of the nozzle.

14. The inlet nozzle of claim 12 including a compressor for drawing ambient air through the molded inlet nozzle and the filter housing; and
a concentrator for extracting oxygen from the ambient air.

15. The inlet nozzle of claim 11 including a flange on said housing for mounting said inlet nozzle on a filter housing.

16. The inlet nozzle of claim 11 wherein the fluid passages are spaced from each other and a sidewall of an inlet conduit.

17. The inlet nozzle of claim 16 when the throat plate extends substantially normal to a sidewall of the inlet conduit.

18. The inlet nozzle of claim 16 wherein the at least one fluid passage converges for about half its length.
